(19) United States
(12) Patent Application Publication
(10) Pub. No.: US 2013/0166597 A1
(43) Pub. Date: Jun. 27, 2013

(54) Context Object Linking Structured and Unstructured Data

(71) Applicants: Mohammad Asif Khan, Palo Alto, CA (US); Christian Butzlaff, Menlo Park, CA (US); Christian Hauschild, Walldorf (DE)

(72) Inventors: Mohammad Asif Khan, Palo Alto, CA (US); Christian Butzlaff, Menlo Park, CA (US); Christian Hauschild, Walldorf (DE)

(73) Assignee: SAP AG, Walldorf (DE)

(21) Appl. No.: 13/334,828

(22) Filed: Dec. 22, 2011

(51) Int. Cl. G06F 17/30

(52) U.S. Cl. 707/792; 707/E17.055

(57) ABSTRACT

A context object provides an interface between structured data present in a database, and relevant unstructured data that is available outside of the database. The context object includes an objective, and access to unstructured data is determined based upon the objective. According to certain embodiments a context object may be configured to store meta information related to the structured data, for example references in the form of active links to pertinent entries in an email system, a social network, a wild, and/or blog. Maintenance of the context object may be achieved through automated crawling techniques and/or manual intervention by the user.

### BACKGROUND

The present invention relates to computing, and in particular, to systems and methods for storing data in a database.

Unless otherwise indicated herein, the approaches described in this section are not prior art to the claims in this application and are not admitted to be prior art by inclusion in this section.

Many business processes contain both structured and nonstructured information. Structured information is typically captured in Enterprise Resource Planning (ERP) systems, Customer Relationship Management (CRM) systems, Supply Network Collaboration (SNC) systems, or similar systems. Structured information may be stored in data structures, reflecting purchase orders, contracts, product master records, customer master records, employee records, or similar data.

Data structures may be the result of a data model, which defines their structure. For example a purchase order can be defined by a data model and its structure, to contain a hierarchy of levels and data fields.

By contrast, unstructured data is typically not defined by a data structure. Examples of unstructured data include but are not limited to e-mails, phone conversations, text documents, pictures, or websites. An example of a subcategory of unstructured data includes but are not limited to Web2.0 social data, such as TWITTER feeds, FACEBOOK entries, LINKEDIN data, or other discussion forums such as blogs and/or wikis.

While conventional databases typically store information in structured form, both structured and unstructured data types may be relevant to provide valuable context to a particular business process. For example in an SNC environment, an e-mail from a supplier asking a question pertaining to an existing purchase order (PO), is relevant to the context of that PO.

The present disclosure addresses these and other issues with systems and methods allowing the linking of structured information contained in databases, with related information from unstructured sources such as email or social networks.

### SUMMARY

A context object provides an interface between structured data present in a database, and relevant unstructured data that is available outside of the database. The context object includes an objective, and access to unstructured data is determined based upon the objective. According to certain embodiments a context object may be configured to store meta information related to the structured data, for example references in the form of active links to pertinent entries in an email system, a social network, a wild, and/or blog. Maintenance of the context object may be achieved through automated crawling techniques and/or manual intervention by the user.

An embodiment of a computer-implemented method, comprises, providing a database comprising an object storing structured data according to a data structure; providing a linkage between the object and a context object comprising an objective; based upon the objective, causing the context object to store unstructured data relevant to the object; and displaying the unstructured data to a user of the database.

An embodiment of a non-transitory computer readable storage medium embodying a computer program for performing a method, said method comprises providing a linkage between an object storing structured data of a database according to a data structure, and a context object comprising an objective; based upon the objective, causing the context object to store unstructured data relevant to the object; and displaying the unstructured data to a user of the database.

An embodiment of a computer system comprises one or more processors and a software program executable on said computer system, the software program configured to: provide a linkage between an object storing structured data of a database according to a data structure, and a context object comprising an objective; based upon the objective, causing the context object to store unstructured data relevant to the object; and display the unstructured data to a user of the database.

In certain embodiments the unstructured data may comprise meta information.

In some embodiments the unstructured data may comprise a reference.

According to particular embodiments, the unstructured data may comprise a subject of an e-mail.

In some embodiments the unstructured data comprises a title of a document, or a key word of a web page.

In certain embodiments the unstructured data comprises an entry from a social network.

The following detailed description and accompanying drawings provide a better understanding of the nature and advantages of the present invention.

### BRIEF DESCRIPTION OF THE DRAWINGS

FIG. 1 shows a general overview of the implementation of an embodiment of a context object with a database.

FIG. 2 shows the data structure of one embodiment of a context object.

FIG. 3 shows a general overview of the implementation of an embodiment of a context object with a database of a SNC system.

FIG. 4 is a schematic view showing the entities involved in an example of a context object referenced in a SNC system.

FIG. 4A is a schematic chart showing a process flow according to an embodiment.

FIG. 5 illustrates hardware of a special purpose computing machine which may be used to implement a context object according to an embodiment.

FIG. 6 illustrates an example of a computer system.

### DETAILED DESCRIPTION

The apparatuses, methods, and techniques described below may be implemented as a computer program (software) executing on one or more computers. The computer program may further be stored on a computer readable medium. The computer readable medium may include instructions for performing the processes described below.

In the following description, for purposes of explanation, examples and specific details are set forth in order to provide a thorough understanding of various embodiments of the present invention. It will be evident, however, to one skilled in the art that the present invention as defined by the claims may include some or all of the features in these examples alone or in combination with other features described below, and may further include modifications and equivalents of the features and concepts described herein.

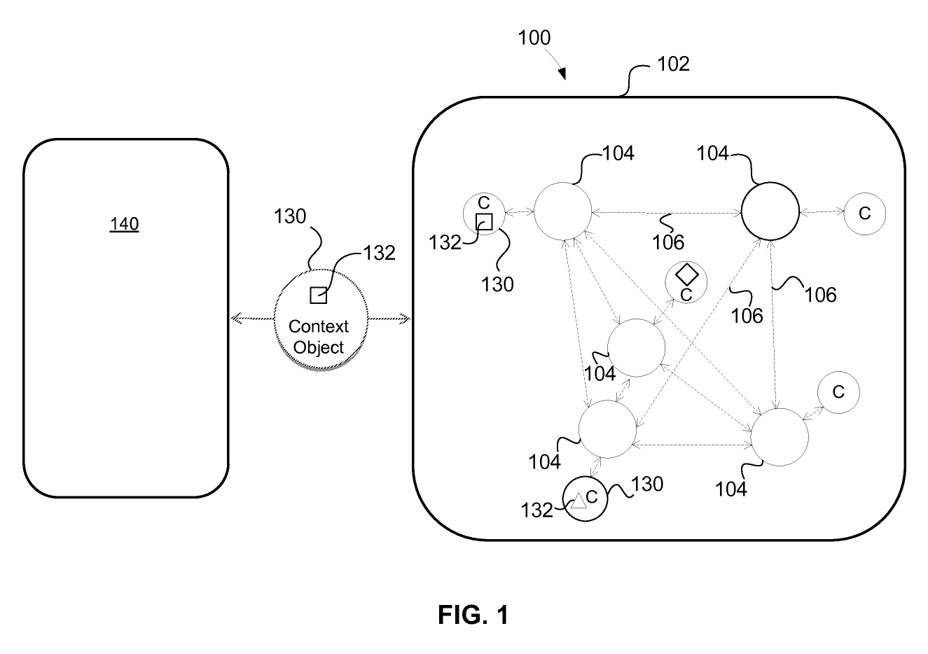

FIG. 1 is a general depiction of the incorporation of a context object with a database in an embodiment. In particular, system 100 comprises database 102 having a plurality of objects 104 that are configured to store data according to data structures.

In certain embodiments, the database of which the context object forms a part, may comprise a relational database created in Structured Query Language (SQL) and having data stored in rows and columns However this is not required.

For example, in other embodiments the database may comprise other types of databases, for example a graphical database or a High Performance Analytic Appliance (HANA) available from SAP AG of Walldorf, Germany. Examples of other database types include but are not limited to Hadoop/HBase, Cassandra, Amazon SimpleDB, Big Table.

The dashed lines in FIG. 1 depict the linkages 106 between the various objects of the database. These linkages indicate relationships between the objects that may be exploited to obtain a richer understanding of the phenomenon being represented by the data of the database.

For example, in a particular embodiment the database may be used to store information related to a supply chain. Certain individual objects of the database may thus represent various entities in the supply chain, for example customers, vendors, and suppliers.

The data stored within of these objects may be organized according to data structures that include fields and hierarchical levels. For example, a contact level may include fields for contact person, contact address, and telephone number. A product level may include fields for individual product names, product prices, and Stock Keeping Unit (SKU) numbers.

Other individual objects of the database may represent transactions between those entities of the supply chain. For example a purchase order may comprise a separate object. The data structure of a purchase order object may include fields for purchase order number, order date, delivery date, product names, itemized price, and total price etc.

In the SNC example, linkages between objects comprising entities of the supply chain, and objects comprising transactions, may allow for a rich understanding of the relationships of the supply chain. For example, an e-mail from a supplier providing clarifying information about a product listed in a Purchase Order. Linking the e-mail with the purchase order allows for a better understanding of both items, and facilitates subsequent location of, and reference to, these items.

As indicated above, unstructured information may provide important insights into the phenomena being represented by the database. Accordingly, in order to facilitate the linkage of structured and unstructured information, one or more context object(s) are introduced, each having an objective. The context object holds references to different information sources (structured as well as unstructured) that are related to the overall objective of the context. These references may be in the form of (active) links to sites available on the Internet or on a particular intranet.

For example, if the objective of a context object is defined as a specific product, the context object may contain data relating to the structured product master record, as well as any e-mails associated with this product, Web 2.0 content (TWITTER, FACEBOOK, . . . ) associated with this product and potentially many more.

Accordingly, FIG. 1 shows a plurality of context objects 130, each of which is associated with the various objects 104 of the database 102, through linkages 106. In various embodiments, the context object may reside within, or alternatively be stored outside of, the database itself. Each context object 130 includes a corresponding objective 132.

Utilizing one of the respective context objects (which are also shown collectively for purposes of illustration as a single context object in FIG. 1), one or more database objects may gain access to unstructured contextual information 140 that is available outside the structured environment of the database.

In certain embodiments, the context object may contain data in the form of meta information. An example of such meta information is a link to remote information source, for example as may be available over the internet. Other examples of meta information which may be stored by a context object are the subject of an e-mail, the title of a document, and/or key words of a web page.

In certain embodiments, the context object may contain data in addition to or in lieu of meta information. For example, the context object may include data in the form of the relevant information itself. In certain embodiments, the context object may contain the result of text analysis, such as transcription of audio content (e.g. a phone call) or optical character recognition (OCR) (e.g. of an image).

Once structured and unstructured information is linked together utilizing a context object, a search within this context offers a new way of locating and/or responding to information. For example in a customer support scenario, the report of an issue with a product can retrieve a variety of unstructured information (i.e. discussions) about the product. A solution to the problem might be found in Web forums or e-mails otherwise inaccessible from within the particular application in which a service ticket is filed.

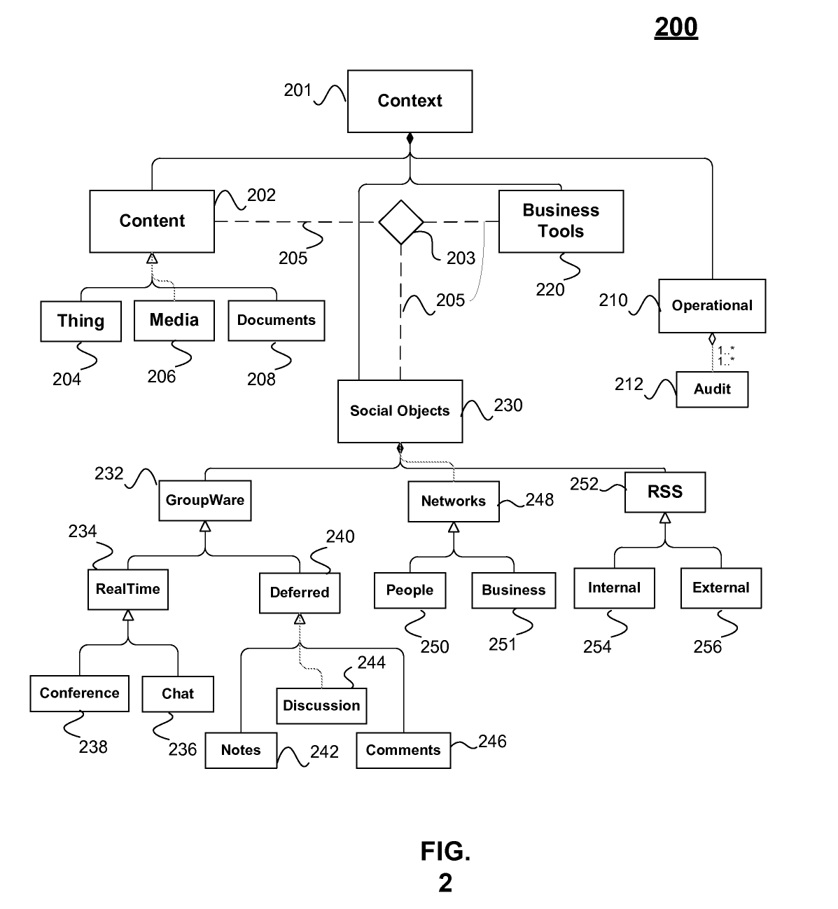

FIG. 2 shows one example of the data structure 200 of an embodiment of a context object 201. Context object 201 comprises objective 203.

In the embodiment of FIG. 2, the objective is depicted as a diamond having a ternary association 205 between three (3) classes of objects (Content, Social Objects, and Business Tools). The objective serves the relevant results as per the question asked.

The objective is flexible and dynamic in the object, and morphs itself with ever changing associations. For example, if a context object has one-hundred (100) associations, the object which a user wants may only want 10 associations. Thus the objective controls that aspect.

The context object 201 includes data stored in various fields and organized according to various hierarchies. For example, in the particular context object of FIG. 2, content data 202 comprises a thing field 204, a media field 206, and a documents field 208.

These represent components of the unstructured object, but a link is maintained to identify the parent cause. Specifically a context object has a structured object as it parent object. Before being associated to the context, components of the context object (such as the Social Objects discussed below) go through manual or automated filter processes to reduce noise. Business Tools and Operational data are created as per company/use case needs.

The data structure of the context object further comprises operational data 210, which may be organized at a level higher than constituent audit data 212. Operational data may include but is not limited to, audit trails, policy guidelines, access controls for unstructured objects, and others as may be needed according to company operational demands and policies.

The data structure of the context object further comprises business tool data 220. This data identifies various business tools, for example the location of specific ERP and SNC systems. Business users may desire information, both structured and unstructured, to address business events and needs. Business Tools such as Meeting Template, Agenda Builders, Relevant people, and others fed automatically from a context object may serve to improve efficiency, and vice-versa improve a richness of the structured object.

Finally, the data structure of the context object further comprises data from one or more unstructured data sources, and organized in a hierarchical manner. Here, the data is organized in a hieratical manner under the highest level of “Social Objects” 230.

Included within this highest level 230 is data 232 available from GroupWare sources. Such GroupWare data 232 may be available as real time information 234, for example in the form of chat 236 and/or conference 238). GroupWare information may also be other than real time, for example deferred information 240 such as notes 242, discussion 244, or comments 246.

Another hierarchy within the “Social Objects” grouping, is data 248 available from networks. Such data providing context may be provided both from personal-oriented networks 250 (for example FACEBOOK, LINKEDIN), as well as business networks 251 (for example a company's intranet).

Still another hierarch within the “Social Objects” grouping, is data available from RSS (“RDF Site Summary”/“Rich Site Summary”/“Really Simple Syndication”) feeds 252. Again, these feeds may be taken from sources internal 254 or external 256 to a particular organization.

In order to ensure that the context object does not contain too much information of limited quality or limited relevance, one or more of the following characteristics of the context objects may be defined.

(1) A context object may contain an objective. In the example of a purchase order, the objective could be the related purchase order. The context object describes the context of something. When a context object is created (manually or automatically), it is created for a specific objective in mind For example, when creating a particular PO, the creator might choose to create a context object in order to reference together relevant information, such as e-mails, documents, wild entries, supplier web sites etc. In this case, the objective is the purchase order. The creator could also decide to create a context object for the supplier, linking supplier-relevant information. There, the purchase order based context object could store a reference to the second, supplier based context object having that objective, and vice-versa.

(2) The initial creation of a context object can be manual or automatic. For example, the creation of a purchase order can either automatically trigger the creation of an associated context object. Alternatively the context object is created by a manual action, for example by the act of a purchasing agent.

(3) A new entry into an existing content object can be made automatically or manually. In the former case, for example, a purchasing agent might want to link a specific e-mail to the context object. For the latter case, a report can periodically scan feeds (such as TWITTER feeds) for words related to the objective of the context object. In the example of a purchase order this could be the product or the supplier listed in the purchase order.

(4) An entry in the context object can contain additional metadata. According to some embodiments, the context object may not store all relevant information directly. Rather, in order to conserve storage resources, the context object may store only reference(s), and corresponding metadata for each reference. The metadata can describe the reference and can be used for searching within the context objects.

(5) A context object can be maintained and administered by a context object owner. The context object owner is a specific end user with specific authorization. For example, the context object owner could be the context object creator, or another end user having this authority

In order to facilitate more accurate search results and eliminate unrelated information from the context object(s), the end user may be able to maintain the content. This includes the deletion of entries as well as the manual addition of metadata information. Maintenance of the context object may be achieved through automated crawling techniques and/or manual intervention by the user.

### Example

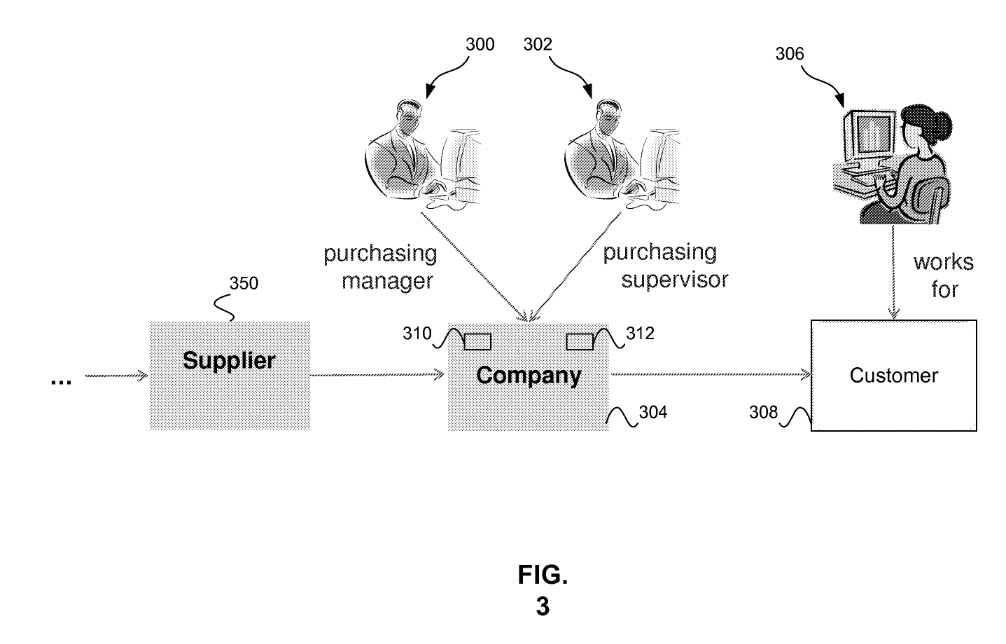

The following example illustrates use of a context object in the environment of a supply chain. FIG. 3 illustrates the individuals and entities involved in the supply chain.

Specifically, in this example individuals 300 and 302 are working for a company 304 as a purchasing manager and supervisor, respectively. Individual 306 is working for a customer 308 of the company.

The purchasing manager 300, opens an email and identifies that a current mail message 310 is associated with a specific purchase order (PO) 312. Accordingly, purchasing manager 300 wishes to assign the mail message to that purchase order using a macro of his email program.

First, the purchasing manager 300 opens the PO in the SNC tool, and checks if the purchase order in question already has a context object or not. If no context object exists for the purchase order, one is created.

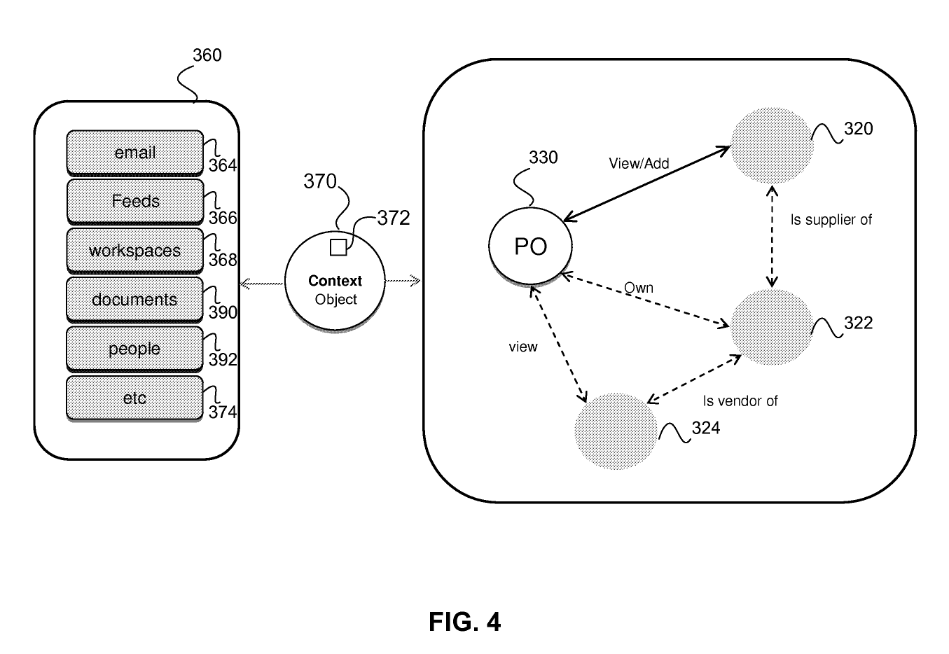

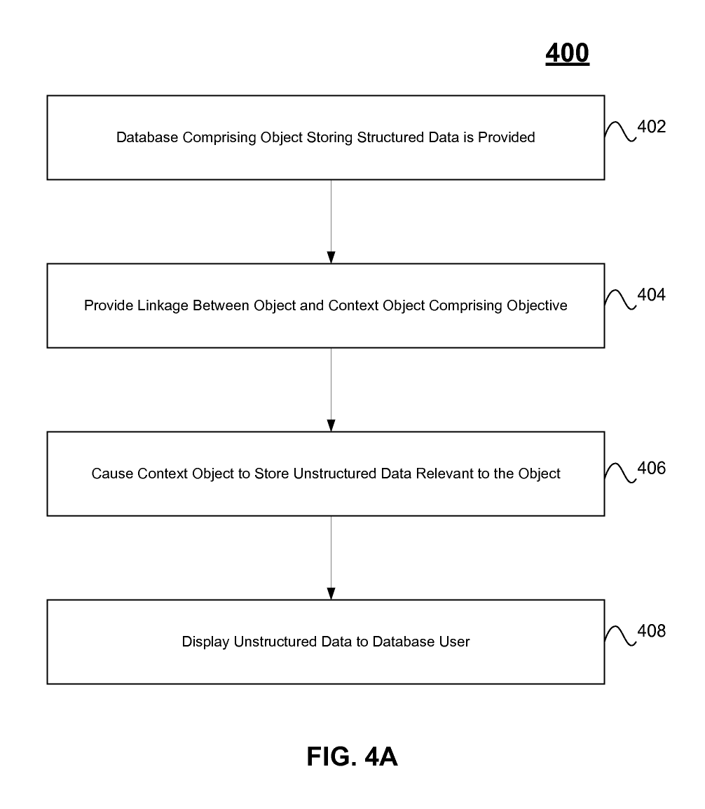

FIG. 4 shows a general view of the relationship between structured information of the database, the context object, and the nonstructured information in this example. The SNC database 350 includes a first object 320 corresponding to a supplier 350 of the company 304. Object 322 corresponds to the business 304. Object 324 corresponds to the customer 308.

In the course of a business translation, the customer 308 requests a good or service from the company 304. In order to meet this request, the company is required to purchase goods from its supplier. The company thus issues a purchase order 312 documenting this transaction. The purchase order is represented in the database as object 330.

All three entities 304, 308, and 350 may seek access to accurate and up-to-date information regarding the purchase order. For example, the business 304 is interested in viewing the purchase order to keep track of expenditures. The supplier 306 is interested in viewing the purchase order as it may need to supply materials to allow the business to meet its obligation to the business. The customer 308 is interested in viewing the purchase order to ensure that its request to the business will ultimately be satisfied.

In addition to the structured information represented by the purchase order itself, unstructured information 360 in various forms, may be relevant to inform the different entities of the status of the transaction. Examples of such unstructured information include but are not limited to email 364, Feeds 366, workspaces 368, documents 390, people 392, and other sources 374 such as blogs etc.

Accordingly, the context object 370 including objective 372, may provide a link between the structured information of the PO object of the database and unstructured information relevant thereto, allowing the latter to be stored within a database.

After the purchasing manager 300 has confirmed that the Purchase Order has a context object, he assigns the mail message to that context object using an email macro.

The system may also be configured to read other sources of context information. For example, the system may be configured to read feeds from TWITTER. Accordingly, using the context object 370 the system may associate with the structured information of the PO object, additional sources of context information in unstructured form.

The purchasing supervisor 302 looks at the PO in the SNC. The purchasing supervisor 302 can quickly access the context of the purchase order to get up-to-date underlying information. For example, the purchasing supervisor 302 may click a View Context button present in the graphic user interface (GUI) of the SNC system.

Further to this example scenario, the purchasing supervisor 302 may notice that one of the assigned TWITTER-feeds is also relevant for a second PO. Accordingly, the purchasing supervisor adds a description to this tweet and assigns it to the second PO as well.

The purchasing supervisor 306 works for customer 308 of the company. Previously, customer purchasing supervisor 306 received the rights from company 304 (her supplier), to view all context which is assigned.

The customer purchasing supervisor 306 is accordingly empowered to view the context in order to get an overview of her purchase. For example, a TWITTER entry describing production quality problems of the supplier, is relevant to inform the customer of potential issues. In such a case the customer might wish to attach the TWITTER information to a supplier's structured master record, for future reference.

FIG. 4A shows a simplified summary of a process flow 400 reflecting steps of a method according to an embodiment. In a first step 402, a database is provided comprising an object storing structured data according to a data structure. In a second step 404, a linkage is provided between the object and a context object comprising an objective. In a third step 406, based upon the objective, the context object is caused to store unstructured data relevant to the object. In a fourth step 408, the unstructured data is displayed to a user of the database.

The use of a context object according to particular embodiments, may offer certain benefits. One possible benefit is ease of recollection of rich conversations that may lie behind tasks on a business object.

Another possible benefit is to facilitate search of business objects via related terms. In particular, searching across a set of relevant context objects reduces the searchable space, improves accuracy, and enhances the speed of returning the results. For example in searching for information of a specific supplier, an end user would only need to search through the relevant context objects rather than the entire information space of unstructured data. This reduces the incidence of unrelated search results and therefore improve accuracy and speed.

Still another possible benefit is to align the stored information more closely with human thought patterns. For example, people tend to remember information more in terms of accounts, people, and content, rather than abstract codes (such as particular PO numbers).

Another possible benefit of a context object is to reduce cost. In particular, cost efficiency may be enhanced by reducing the overhead associated with having to recreate information that may already be present in an unstructured form (i.e. email, entry on social networking site).

Embodiments of the present invention may also offer the benefit of cost savings by allowing new colleagues to be brought on-board more quickly. For example, a new hire may have access to historical information relevant to a particular account, much more rapidly through the use of an embodiment of a context object.

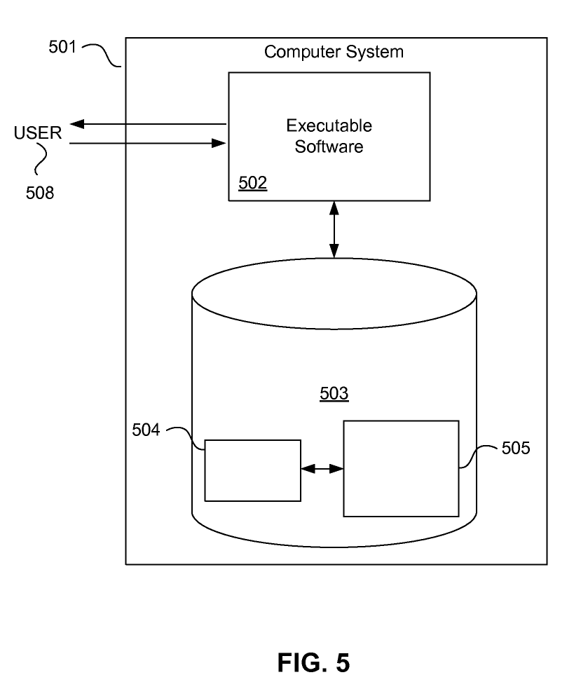

FIG. 5 illustrates hardware of a special purpose computing machine which may correspond to a client remote from the server including the database. This computing machine may be configured to implement query visualization and/or optimization according to certain embodiments.

In particular, computer system 500 comprises a processor 502 that is in electronic communication with a non-transitory computer-readable storage medium 503. This computer-readable storage medium has stored thereon code 505 corresponding to the database, including objects thereof. Code 504 corresponds to a context object according to various embodiments. Code may be configured to allow data stored in a database of a non-transitory computer-readable storage medium to be accessed remotely by a user 508, for example through a computer network by a remote client having an appropriate user interface.

Embodiments of context objects may be run in conjunction with a computer system which may comprise a software server. A number of software servers together may form a cluster, or logical network of computer systems programmed with software programs that communicate with each other and work together to process requests.

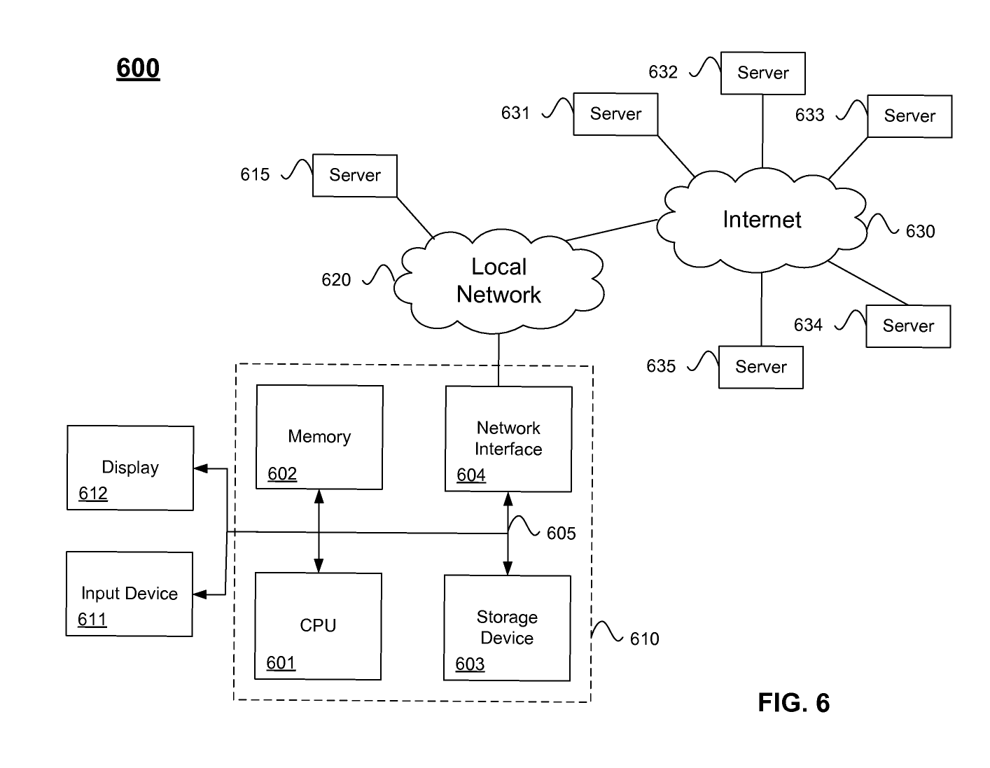

An example computer system 610 is illustrated in FIG. 6. Computer system 610 includes a bus 605 or other communication mechanism for communicating information, and a processor 601 coupled with bus 605 for processing information.

Computer system 610 also includes a memory 602 coupled to bus 605 for storing information and instructions to be executed by processor 601, including information and instructions for performing the techniques described above, for example. This memory may also be used for storing variables or other intermediate information during execution of instructions to be executed by processor 601. Possible implementations of this memory may be, but are not limited to, random access memory (RAM), read only memory (ROM), or both.

A storage device 603 is also provided for storing information and instructions. Common forms of storage devices include, for example, a hard drive, a magnetic disk, an optical disk, a CD-ROM, a DVD, a flash memory, a USB memory card, or any other medium from which a computer can read.

Storage device 603 may include source code, binary code, or software files for performing the techniques above, for example. Storage device and memory are both examples of computer readable media. The computer system generally described in FIG. 6 includes at least those attributes described in FIG. 5.

Computer system 610 may be coupled via bus 605 to a display 612, such as a cathode ray tube (CRT) or liquid crystal display (LCD), for displaying information to a computer user. An input device 611 such as an in-vehicle touch screen, is coupled to bus 605 for communicating information and command selections from the user to processor 601. The combination of these components allows the user to communicate with the system. In some systems, bus 605 may be divided into multiple specialized buses.

Computer system 610 also includes a network interface 604 coupled with bus 605. Network interface 604 may provide two-way data communication between computer system 610 and the local network 620. The network interface 604 may be for Broadband Wireless Access (BWA) technologies. In any such implementation, network interface 604 sends and receives electrical, electromagnetic, or optical signals that carry digital data streams representing various types of information.

Computer system 610 can send and receive information, including messages or other interface actions, through the network interface 604 across a local network 620, an

Intranet, or the Internet 630. For a local network, computer system 610 may communicate with a plurality of other computer machines, such as server 615. Accordingly, computer system 610 and server computer systems represented by server 615 may form a cloud computing network, which may be programmed with processes described herein.

In an example involving the Internet, software components or services may reside on multiple different computer systems 610 or servers 631-635 across the network. The processes described above may be implemented on one or more servers, for example. A server 631 may transmit actions or messages from one component, through Internet 630, local network 620, and network interface 604 to a component on computer system 610. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method comprising:
providing a database comprising an object storing structured data according to a data structure;
providing a linkage between the object and a context object comprising an objective;
based upon the objective, causing the context object to store unstructured data relevant to the object; and
displaying the unstructured data to a user of the database.

2. The method of claim 1 wherein the unstructured data comprises meta information.

3. The method of claim 1 wherein the unstructured data comprises a reference.

4. The method of claim 1 wherein the unstructured data comprises a subject of an e-mail.

5. The method of claim 1 wherein the unstructured data comprises a title of a document, or a key word of a web page.

6. The method of claim 1 wherein the unstructured data comprises an entry from a social network.

7. A non-transitory computer readable storage medium embodying a computer program for performing a method, said method comprising:
providing a linkage between an object storing structured data of a database according to a data structure, and a context object comprising an objective;
based upon the objective, causing the context object to store unstructured data relevant to the object; and
displaying the unstructured data to a user of the database.

8. The non-transitory computer readable storage medium of claim 7 wherein the unstructured data comprises meta information.

9. The non-transitory computer readable storage medium of claim 7 wherein the unstructured data comprises a reference.

10. The non-transitory computer readable storage medium of claim 7 wherein the unstructured data comprises a subject of an e-mail.

11. The non-transitory computer readable storage medium of claim 7 wherein the unstructured data comprises a title of a document, or a key word of a web page.

12. The non-transitory computer readable storage medium of claim 7 wherein comprises an entry from a social network.

13. A computer system comprising:
one or more processors;
a software program, executable on said computer system, the software program configured to:
provide a linkage between an object storing structured data of a database according to a data structure, and a context object comprising an objective;
based upon the objective, causing the context object to store unstructured data relevant to the object; and
display the unstructured data to a user of the database.

14. The computer system of claim 13 wherein the unstructured data comprises meta information.

15. The computer system of claim 13 wherein the unstructured data comprises a reference.

16. The computer system of claim 13 wherein the unstructured data comprises a subject of an email.

17. The computer system of claim 13 wherein the unstructured data comprises a title of a document, or a key word of a web page.

18. The computer system of claim 13 wherein the unstructured data comprises an entry from a social network.
